(19) United States
(12) Patent Application Publication
(10) Pub. No.: US 2004/0157944 A1
(43) Pub. Date: Aug. 12, 2004

(54) Preparation method for foaming waterborne PU

(75) Inventors: Lien-Hua Chiu, Yunghe City (TW); Yen-Shyi Lin, Taipei (TW)

Correspondence Address: TROXELL LAW OFFICE PLLC, Suite 1404, 5205 Leesburg Pike, Falls Church, VA, 22041, US

(73) Assignee: China Textile Institute

(21) Appl. No.: 10/359,686

(22) Filed: Feb. 7, 2003

(51) Int. Cl. C08J 9/00; C08G 18/00

(52) U.S. Cl. 521/155

(57) ABSTRACT

The present invention relates to a preparation method for foaming waterborne PU, which is performed by adding hydrocarbon with a high boiling point to a waterborne PU pre-polymer, allowing hydrocarbon to be encapsulated by waterborne PU and dried to form voids. A composition and the preparation method of this waterborne PU can be effectively applied to textile coating and leather fabrication.

### BACKGROUND OF THE INVENTION

(a) Field of the Invention

The present invention relates to a preparation method for foaming waterborne PU, whereby a waterborne PU pre-polymer is introduced with hydrocarbon having a high boiling point to allow hydrocarbon to be encapsulated in waterborne PU and dried in an oven to form voids of foaming waterborne PU whose composition and the preparation method can be effectively applied to textile coating and leather fabrication.

(b) Description of the Related Art

Current PU micro-porous technology has considerably many applications in the industry, such as being widely applied to wet fabrication of waterproof textile and synthetic leather. This PU micro-porous technology generally can be divided into three aspects; one is to properly emulsify PU to form W/O emulsified resin and gradually volatilize solvents from the resin with different volatile rates in an oven, so as to form a micro-porous film. This method makes properties of processing agents change with time and processing quality hardly controlled during processing so that this method is not often used in general. Another method is to add an appropriate foaming agent to the resin to produce foam by a physical or chemical reaction; however, voids formed by this method are hardly controlled, making this method not commonly applied to batch fabrication of products. The most widely used PU micro-porous technique is a PU wet coagulation process by which PU resin is coated over a substrate surface and subjected to a coagulation bath, allowing replacement of water with a DMF solvent to form voids and making the resin cure and form a micro-porous film. This porous film has an interconnected beehive structure with a surface pore diameter of 0.5-2μ. Wet-coagulated PU is widely applied to waterproof textile and synthetic leather; however, processing of wet-coagulated PU uses a large amount of DMF solvent that is released during fabrication and causes serious environmental pollution. Further, as governmental restriction to organic solvents is getting severe in recent years, in order to meet legal air discharge standard, manufacturers need to spend more than ten million dollars to improve air discharge equipment, which results in a heavy burden of capital costs to the manufacturers. Therefore, currently made waterborne PU is primarily used to replace conventional solvent resin; since waterborne PU complies with requirements of clean production and environmental friendliness, PU resin will become a mainstream product in the future. Generally, current waterborne PU is mostly formed by foam-coating in which resin is mechanically mixed with air to form foaming resin that is applied over textile having air-formed pores and dried to form voids. However, this method can hardly form a well stable foam structure with size and shape of the foam usually changing with time. Moreover, this foam coating can be merely suitable for the use in a particular processing method that usually requires additional foam-producing equipment, thereby further increasing capital costs for the manufacturers. Accordingly, in light of foregoing drawbacks and inconvenience of the current method for foaming waterborne PU, the inventor with spirits of creativeness and expertise develops a preparation method for foaming waterborne PU that is more practical and widely applicable with industrial utility.

### SUMMARY OF THE INVENTION

The present invention relates to a simple method for synthesizing waterborne PU, allowing hydrocarbon having a high boiling point to be encapsulated in a waterborne PU pre-polymer and dried in an oven to form voids. This method can be performed through the use of common processing equipment without requiring a large amount of powerful and expensive equipment.

Referring to FIG. 1 illustrating a flowchart of a preparation method for foaming waterborne PU according to the invention. First, polyol and ionic groups are added to a reactor and mixed at 80° C. for 20 minutes. Diisocyanate is added to the mixture to perform a pre-polymerization reaction for 3-6 hours at 60-90° C. and titration until reaching theoretical NCO %, and then the pre-polymerization reaction is stopped. In the following, a pre-polymer is formed and cooled in air, then added with hydrocarbon to be neutralized. After mixing for 10-20 minutes at 40-60° C., the mixture is added with water under high-speed stirring to form stabilized dispersant, and then a chain extender is slowly added to extend a molecular chain so as to obtain the waterborne PU. The waterborne PU resin allows hydrocarbon to be encapsulated in waterborne PU dispersant and dried to form voids.

The above synthetic composition of waterborne PU includes: polyol (diol or polyol), diisocyanate or polyisocyanates, ionic group, neutralizer, chain extender and water.

Examples of polyhydroxyl components suitably applied to the invention include:

(1) polyether polyol: e.g. polypropylene glycol (PPG), polyethylene glycol (PEG), polytetramethylene ether glycol (PTMG), copolymer of polyethylene glycol-propylene glycol, and the like;

(2) polyester polyol: e.g. polyethylene adipate (PEA), polybutylene adipate (PBA), polyhexylene adipate (PHA), polyneopentyl glycol adipate (PNPG), polycaprolactone (PCL), and the like;

(3) polycarbonate polyol (PC).

Examples of diisocyanate suitably applied to the invention include:

(1) aromatic diisocyanate: toluene diisocyanate (TDI), 4,4-diphemylmethane diisocyanate (MDI), and the like;

(2) aliphatic diisocyanate: hexane-1,6-diisocyanate (HDI), dicyclohexylmethane-4,4-diisocyanate (H₁₂MDI), isophorone diisocyanate (IPDI), and the like;

Examples of the ionic group suitably applied to the invention include: cationic group, anionic group, non-ionic group, and the like.

The hydrocarbon with a high boiling point suitably applied to the invention has a range of boiling point of 100-230° C.

The neutralizer can neutralize cationic emulsion or anionic emulsion by ionization.

The chain extender includes ethylene glycol, propylene glycol, 1,4-butylene glycol, hexylene glycol, ethylene diamine (EDA), 2-(2-amino ethylamino) ethanol (AEEA), and the like.

In conclusion, the invention provides the following benefits:

1. The waterborne PU resin prepared by the invention is formed with voids by drying without having to consume a large amount of expense and energy.

2. Foaming of waterborne PU according to the invention can be accomplished by using common processing equipment without requiring much expensive equipment.

A primary objective of the present invention is to provide a preparation method for foaming waterborne PU through the use of common processing equipment without requiring a large amount of power and capital equipment.

The invention can be more fully understood by reading the following preferred embodiments with reference made to the accompanying drawings.

### BRIEF DESCRIPTION OF THE DRAWINGS

FIG. 1 is a flowchart of a preparation method according to the present invention;

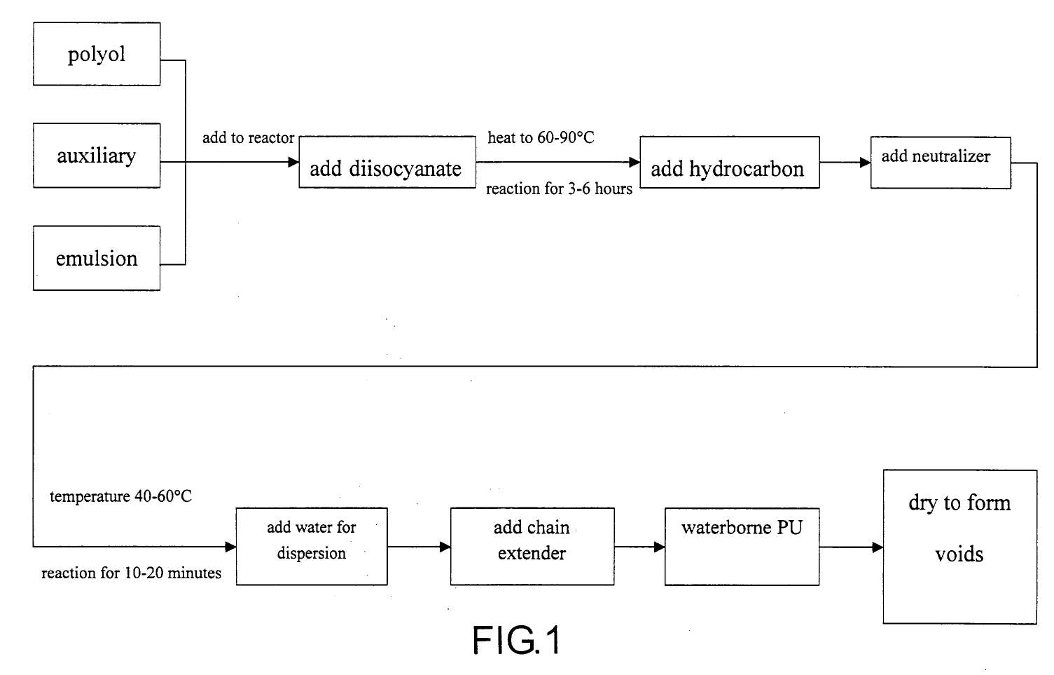

FIG. 2 is a picture of voids formed after drying according to Example 1 of the invention; and

FIG. 3 is a picture of no void formation after drying according to Comparative Example 1 of the invention.

### DESCRIPTION OF THE PREFERRED EMBODIMENTS

### EXAMPLE 1

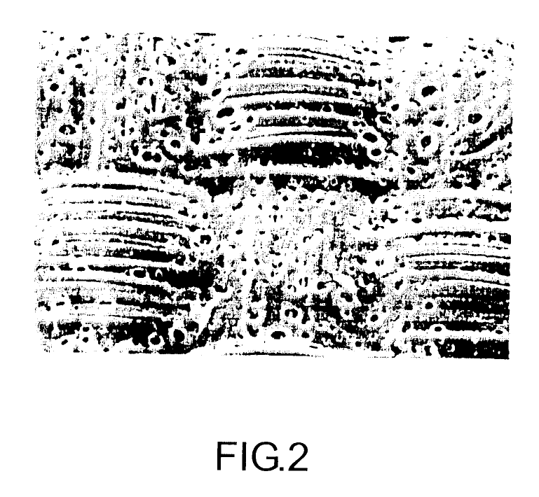

In a 1-liter reactor, 100 g polybutylene adipate (average molecular weight is 2000) and 8.04 g dimethylolpropionic acid (DMPA) are added to a reactor and mixed at 80° C. for 20 minutes. 40.35 g H₁₂MDI is added to the mixture to perform a pre-polymerization reaction for 4-hours and titration according to ASTM-D1638 measurement until reaching theoretical NCO %, and then the pre-polymerization reaction is stopped. In the following, a pre-polymer is formed and cooled in air, and then added with 70 g hydrocarbon and 5.51 g triethylamine (TEA) to neutralize —COOH group of DMPA. After mixing for 15 minutes, the mixture is added with deionized water under high-speed stirring to form stabilized dispersant, and then 1.94 g diluted EDA and 1.44 g AEEA are slowly added to extend the molecular chain so as to obtain waterborne PU resin with about 30% solid content. A waterborne PU film has physical properties of 100%, modulus of 39 kg/cm², tensile strength of 350 kg/cm² and elongation of 400%; this waterborne PU resin allows hydrocarbon to be encapsulated in waterborne PU dispersant and dried to form voids, as shown in FIG. 2.

### EXAMPLE 2

In a 1-liter reactor, 100 g polytetramethylene glycol (average molecular weight is 2000) and 8.04 g DMPA are added to a reactor and mixed at 80° C. for 20 minutes. 40.35 g H₁₂ MDI is added to the mixture to perform a pre-polymerization reaction for 4 hours and titration according to ASTM-D1638 measurement until reaching theoretical NCO %, and then the pre-polymerization reaction is stopped. In the following, a pre-polymer is formed and cooled in air, and then added with 50 g hydrocarbon and 5.51 g TEA to neutralize —COOH group of DMPA. After mixing for 15 minutes, deionized water is added and mixed with the mixture by high-speed stirring to form stabilized dispersant, and then 1.94 g diluted EDA and 1.44 g AEEA are slowly added to extend the molecular chain so as to obtain waterborne PU resin with about 30% solid content. A waterborne PU film has physical properties of 100%, modulus of 40 kg/cm², tensile strength of 390 kg/cm² and elongation of 450%; this waterborne PU resin allows hydrocarbon to be encapsulated in waterborne PU dispersant and dried to form voids.

### EXAMPLE 3

In a 1-liter reactor, 100 g polybutylene adipate (average molecular weight is 2000) and 8.04 g DMPA are added to a reactor and mixed at 80° C. for 20 minutes. 25.87 g HDI is added to the mixture to perform a pre-polymerization reaction for 2 hours and titration according to ASTMD1638 measurement until reaching theoretical NCO %, and then the pre-polymerization reaction is stopped. In the following, a pre-polymer is formed and cooled in air, and then added with 1200 g hydrocarbon and 5.51 g TEA to neutralize —COOH group of DMPA. After mixing for 15 minutes, deionized water is added and mixed with the mixture by high-speed stirring to form stabilized dispersant, and then 2.77 g diluted EDA is slowly added to extend the molecular chain so as to obtain waterborne PU resin with about 30% solid content. A waterborne PU film has physical properties of 100%, modulus of 34 kg/cm², tensile strength of 330 kg/cm² and elongation of 350%; this waterborne PU resin allows hydrocarbon to be encapsulated in waterborne PU dispersant and dried to form voids.

### COMPARATIVE EXAMPLE 1

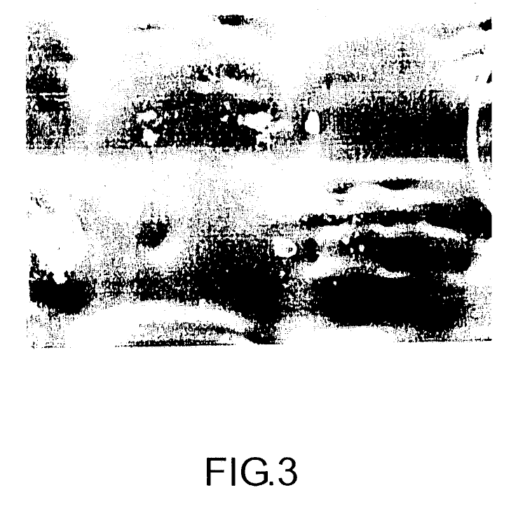

In a 1-liter reactor, 100 g polybutylene adipate (average molecular weight is 2000) and 8.04 g DMPA are added to a reactor and mixed at 80° C. for 20 minutes. 40.35 g H₁₂ MDI is added to the mixture to perform a pre-polymerization reaction for 4 hours and titration according to ASTMD1638 measurement until reaching theoretical NCO %, and then the pre-polymerization reaction is stopped. In the following, a pre-polymer is formed and cooled in air, and then added with 5.51 g TEA to neutralize —COOH group of DMPA. After mixing for 15 minutes, deionized water is added and mixed with the mixture by high-speed stirring to form stabilized dispersant, and then 1.94 g diluted EDA and 1.44 g AEEA are slowly added to extend the molecular chain so as to obtain waterborne PU resin with about 30% solid content. In this waterborne PU resin, no hydrocarbon is encapsulated in waterborne PU dispersant, thereby making no void formed after drying as shown in FIG. 3.

In conclusion, the preparation method for foaming waterborne PU according to the invention is accomplished through the use of common processing equipment without requiring a large amount of powerful and expensive equipment. Therefore, the present invention truly has novelty and inventive step to comply with requirements for a patent.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A preparation method for foaming waterborne PU and a synthetic composition of waterborne PU, characterized by the steps that a waterborne PU pre-polymer is added with hydrocarbon having a high boiling point, whereby the hydrocarbon disperses uniformly in waterborne PU dispersant during emulsification, and a chain extender is used to extend a waterborne PU chain, so as to form waterborne PU with voids after drying, wherein the synthetic composition of waterborne PU comprises: polyol, polyisocyanates, ionic group, neutralizer, chain extender and water.

2. The preparation method of claim 1, wherein the polyol comprises polyester polyol, polyether polyol, polycarbonate polyol and polylactone polyol, or polyol of mixtures thereof.

3. The preparation method of claim 1, wherein the polyisocyanates applied to waterborne PU comprise: diisocyanate and polyisocyanates, aliphatic diisocyanate, aromatic isocyanates, cycloaliphatic isocyanate, or polyisocyanates of mixtures thereof.

4. The preparation method of claim 1, wherein the ionic group applied to waterborne PU comprises: cationic group, anionic group, non-ionic group and the like.

5. The preparation method of claim 1, wherein the neutralizer applied to waterborne PU is capable of neutralizing cationic group or anionic group by ionization.

6. The preparation method of claim 1, wherein the chain extender applied to waterborne PU is diamine and multi-functional amine.

7. The preparation method of claim 1, wherein the hydrocarbon having a high boiling point has a range of boiling point of 100-230° C., and an added amount thereof is 10-150 w.t % of a total PU amount.

8. The preparation method of claim 1, wherein temperature for drying is 80-200° C.
